(19) United States
(12) Patent Application Publication
(10) Pub. No.: US 2006/0098141 A1
(43) Pub. Date: May 11, 2006

(54) High contrast black-and-white chiral nematic displays

(76) Inventors: Richard C.H. Lee, Hong Kong (HK); Fu On Tsang, Hong Kong (HK)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/304,368

(22) Filed: Dec. 14, 2005

Related U.S. Application Data
(63) Continuation of application No. 10/627,525, filed on Jul. 25, 2003, now abandoned.

(30) Foreign Application Priority Data
Jul. 28, 2002 (GB) 0217384.7
Aug. 1, 2002 (GB) 0217917.4

(51) Int. Cl. G02F 1/1335

(52) U.S. Cl. 349/98

(57) ABSTRACT

The invention relates to a chiral nematic display configuration, typically in liquid crystal displays, comprising a chiral nematic display of controllable planar structure and focal conic structure, characterised by the chiral nematic liquid crystal material being between two transparent substrates having conductive electrodes, the material being between two elliptical polarizers and there being an optical reflector. The invention achieves a high contrast black-and-white display. The displays in the embodiment are first and second optical mode configurations of the black-and-white chiral nematic displays.

This invention describes a new chiral nematic display configuration to achieve high contrast black-and-white display.

Classical liquid crystal displays have been widely used in various applications. Severe viewing angle dependence and high power consumption in backlight are major drawbacks for some applications. There has accordingly been active research in chiral nematic liquid crystals in the last few decades. One of the main features in chiral nematic displays is that the bright state and the dark state are bistable, i.e. stable even when the voltage is not connected. This bistability nature results in image retention and flicker-free viewing. Moreover, driving methods and electro-optic response of chiral nematic displays are different from classical liquid crystal displays and result in no limitation on the maximum multiplexing of the display.

There are in such displays two stable states, namely a planar state and a focal conic state. In the planar state, liquid crystal molecules are aligned in a helix form where the axis of the helix is perpendicular to the display plane. Circular polarized light of wavelength matching the pitch and handedness of the helix is reflected by Bragg reflection. This pitch of the helix structure and hence peak reflection wavelength can be adjusted to a visible range or invisible range of the spectrum. The remaining spectrum passes through the chiral nematic and is unaffected Moreover, for opposite circular polarization, the entire specter passes through the chiral nematic and is not affected. On the other hand, in the focal conic state, the liquid crystals form micro-domains and each domain is a small helix structure and the helical axes are highly tilted from the display normal, more or less parallel to the plane of the display. Light is scattered (backwardly, sidely and mainly forwardly) at the domain boundaries where there is an abrupt change in the optical refractive index. The focal conic state is transparent with haze, and the polarization of transmitted light is destroyed.

In many applications, very high information content displays with good contrast and low power consumption are required Chiral nematic displays have particular advantages of availability in very high resolution, image retention and very low power consumption, high contrast and very wide viewing angles.

According to the invention there is provided a full spectrum black-and-white reflective chiral nematic display, comprising a chiral nematic display of controllable planar structure and focal conic structure, two transparent substrates said substrates having conductive electrodes, two elliptical polarizers, said chiral nematic liquid crystal material being between the two transparent substrates, said liquid crystal material and said transparent substrates being between said polarizers, and the display further comprising an optical reflector.

Thus using the invention, two bistable chiral nematic display configurations can be utilized. Each display has a full spectrum white with high contrasts They have very low power consumption and any driving schemes suitable for driving chiral nematic displays to planar and focal conic states can be applied to the display.

Chiral nematic displays embodying the invention are hereinafter described, byway of example, with reference to the accompanying drawings.

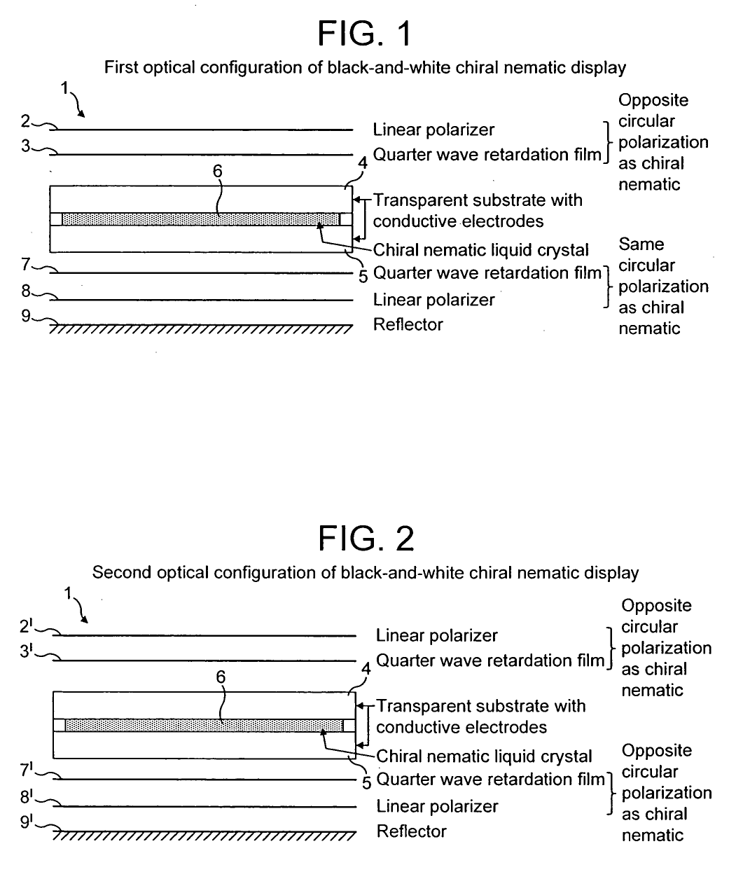

FIG. 1 depicts theist optical configuration of the black-and-white chiral nematic display in this invention;

FIG. 2 depicts the second optical configuration of the black-and-white chiral nematic display in this invention;

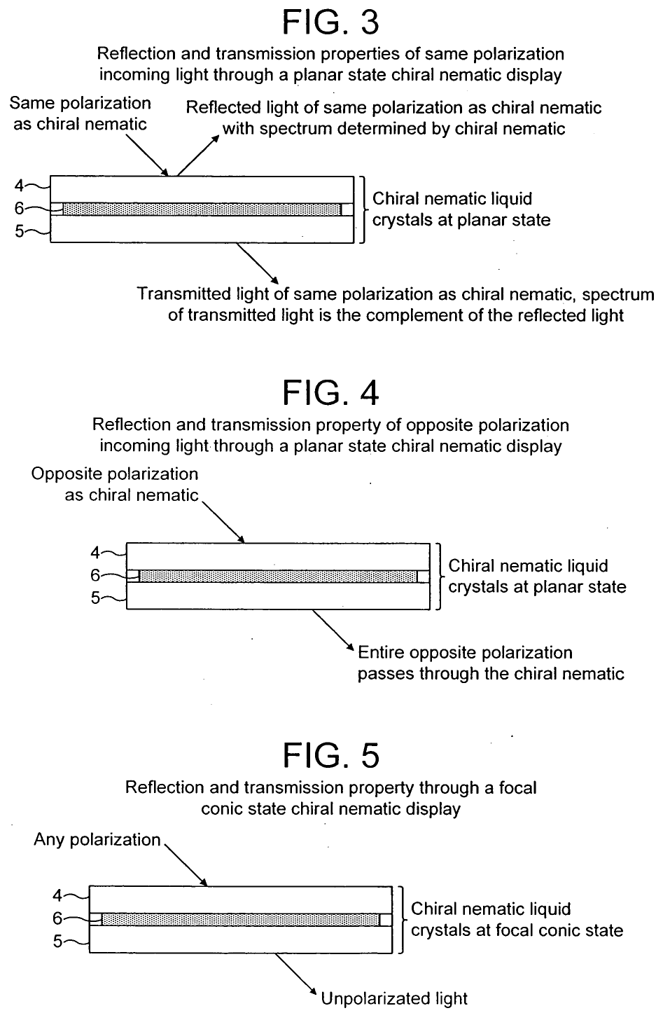

FIG. 3 shows the reflection and transmission properties at the planar state where the incoming light is of the same elliptical polarization as the chiral nematic material;

FIG. 4 shows the reflection and transmission properties at the planar state where the incoming light is of opposite elliptical polarization as the chiral nematic material;

FIG. 5 shows the reflection and transmission properties of the chiral nematic material at the focal conic state;

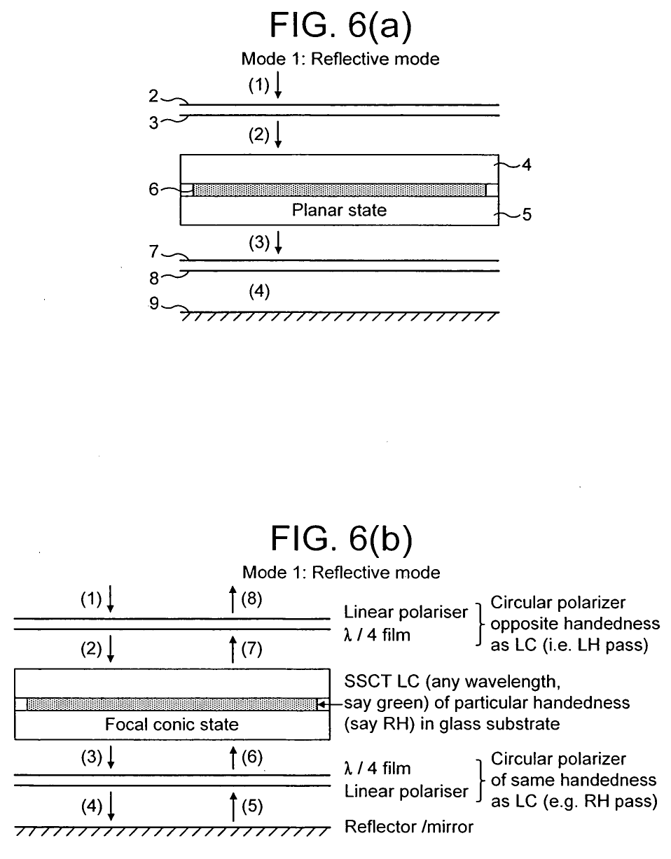

FIG. 6 shows the light paths in the first optical configuration of a black-and-white chiral nematic display in this invention;

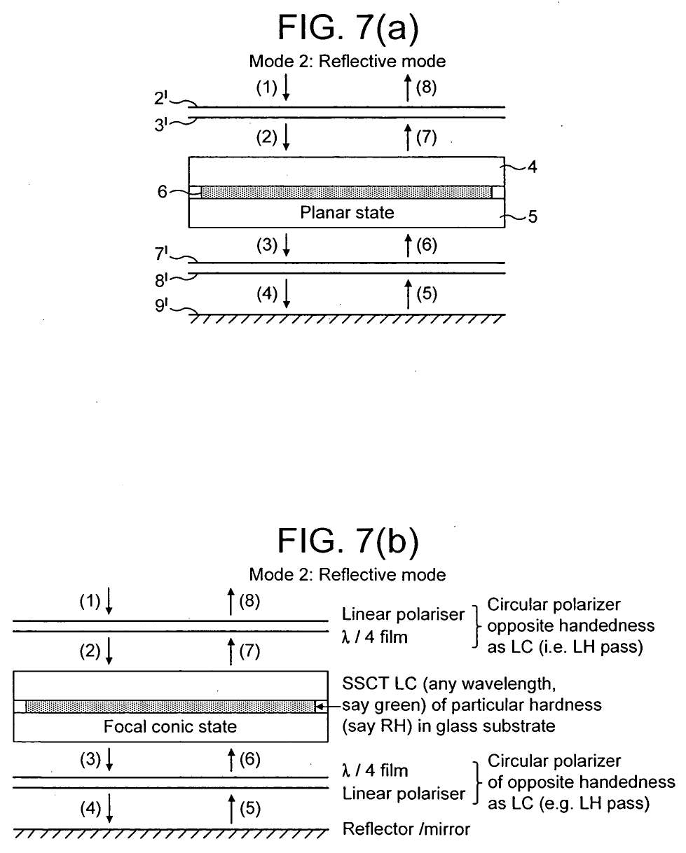

FIG. 7 shows the light paths in the second optical configuration of a black-and-white chiral nematic display in this invention.

Referring to the drawings, in which like parts are indicated by like numbers. In general, chiral nematic displays 1 are disclosed comprising essentially laminates of, as viewed from in front or the top in the drawings, a linear polarizer 2, a quarter wave retardation film 3, front and rear transparent substrates 4, 5 with conductive electrodes and a chiral nematic liquid crystal 6 sandwiched therebetween, a quarter wave retardation film 7, a linear polarizer 8 and a reflector 9.

The linear polarizer 2 and quarter wave retardation film 3 form an opposite circular polarization to the chiral nematic display.

Referring now to a first optical mode configuration as illustrated in FIG. 1, the structures of the first black-and-white chiral nematic display is by adding two elliptical polarizers 2, 3 and 7, 8 of opposite senses (left hand as well as right hand) of handedness and a reflector to the chiral nematic display 6. The elliptical (in particular, circular) polarizers are selected so as to match the polarization type (i.e. circular) of the chiral nematic reflection and transmission. A simple way of making a circular polarizer is to laminate a linear polarizer 2, 8 with a quarter wave retardation film 3. 7 at 45°. The quarter wave retardation film is preferably of wideband. The angle between the linear polarizer and the quarter wave retardation film is adjusted appropriately to give either a left hand circular polarizer or a right hand circular polarizer. The chiral nematic display 6 consists of a chiral nematic liquid crystal material layer of any reflection spectrum and any sense (hand) of circular polarization, sandwiched between the two transparent substrates 4, 5 each with transparent conductive electrodes. The transparent substrates 4, 5 can be of any transparent material not altering the polarization when light is passing through. Examples of such transparent substrates are glass or plastic. The transparent conductive electrodes can be indium tin oxide or tin oxide, for example. The chiral nematic liquid crystal 6 material possesses stable planar state and focal conic state. The chiral nematic display is then sandwiched between the opposite hand elliptical polarizers 2, 3 and 7, 8 where the front elliptical polarizer is of opposite sense to the chiral nematic liquid crystal material and the rear elliptical polarizer is of the same sense as the chiral nematic liquid crystal material. Moreover, the front and rear quarter wave retardation films 3, 7 are facing the respective transparent substrates 4, 5 of the chiral nematic display 6 so that the light entering into the intermediate chiral nematic material from above or below in the entire optical path is elliptically polarized. Below the linear polarizer of the rear elliptical polarizer, a reflector is placed This is the first structural configuration of the black-and-white chiral nematic display embodying the invention.

In the white “ON” state, the chiral nematic liquid crystal 6 materials are in a focal conic state. When unpolarized light passes through the front elliptical polarizer 2, 3, half of the light intensity is absorbed and the remaining carries on into the chiral nematic materials. This light is depolarised by the focal conic structure and becomes linearly polarized with another loss in 50% intensity after passing the rear elliptical polarizer 7, 8. This linear polarized light is reflected by the reflector 9 and goes through the rear elliptical polarizer 7, 8 again. After passing through the chiral nematic material 6 again, the light becomes unpolarized This unpolarized light becomes polarized again after passing through the front elliptical polarizer 2, 3 and the intensity is further reduced by half. The optical path polarized/depolarised /polarized/reflected/depolarised /polarized is independent of wavelength and if the incoming light is white, the outgoing light to the viewer is also white. The intensity at the white “ON” state is 12.5% as the incoming light.

In the dark “OFF” state, the chiral nematic liquid crystal materials are in a planar state. Similar to the “ON” case, the light entering into the chiral nematic material 6 is circularly polarized (opposite sense as the chiral nematic material) with 50% reduction in intensity after passing through the front polarizer. As shown in FIG. 4, this polarized light is unaltered and completely passes through the chiral nematic materials. Then it is totally absorbed by the rear elliptical polarizer (of opposite polarity as the front polarizer). There is no light entering to the mirror and a dark state results. Zero light intensity will be viewed by the viewer.

The second optical mode configuration is illustrated in FIG. 2. The structure of the second black-and-white chiral nematic display embodying the invention is by adding two elliptical polarizers 2′, 3′ and 7′, 8′ of same sense of handedness and a reflector 9′ to the chiral nematic display 4, 5, 6. The sense of the elliptical polarizers 2′, 3′ and 7′, 8′ is opposite to the chiral nematic material 6. The elliptical (to be more precise, circular) polarizers are selected so as to match the polarization type (i.e. circular) of the chiral nematic reflection and transmission A way of making circular polarizer is to laminate a linear polarizer 2′, 7′ with a quarter wave retardation film 3′, 8′ at 45°. The quarter wave retardation film is preferably of wideband. The angle between the linear polarizer and the quarter wave retardation film is adjusted appropriately to give either a left hand circular polarizer or a right hand circular polarizer. The chiral nematic display 6 consists of a chiral nematic liquid crystal material layer, of any reflection spectrum and any handedness, sandwiched between two transparent substrates with transparent conductive electrodes. The transparent substrates can be any transparent material not altering the polarization when light is passing through Examples of such transparent materials can be glass or plastic. The transparent conductive electrodes can be indium tin oxide or tin oxide for example. The chiral nematic liquid crystal material possesses a stable planar state and a focal conic state. The chiral nematic display 6 is then sandwiched between the elliptical polarizers (of opposite sense as the chiral nematic material). Moreover, the front and rear quarter wave retardation films 3′, 7′ are facing the transparent substrate of the chiral nematic display so that any light entering into the intermediate chiral nematic material from above and below in the entire optical path is elliptically polarized Below the linear polarizer of the rear elliptical polarizer, a reflector 9′ is placed This is the second structural configuration of the invented black-and-white chiral nematic display.

In the white “ON” state, the chiral nematic liquid crystal materials are in a planar state. When unpolarized light passes through the front polarizer, half of the intensity is absorbed and the remaining circular polarization goes into the chiral nematic materials. This light (of opposite sense as the chiral nematic material) passes through the chiral nematic material, the rear polarizer, is reflected by the reflector and re-enters the rear polarizer, the chiral nematic material and finally the front polarizer without any change in the polarization and intensity. This outgoing light is viewed by the viewer. The entire light path is independent of wavelength and the reflected light is white colored with light intensity 50% of the original incoming light.

In the dark “OFF” state, the chiral nematic liquid crystal materials are in a focal conic state. Similar to the “ON” case, the light entering into the chiral nematic material is circularly polarized. This polarized light is depolarised by the focal conic chiral nematic material. The depolarised light passes through the rear polarizer, becomes polarized and its intensity is halved. This polarized light is then reflected by the mirror 9′ and re-enters the rear polarizer without any change of polarization and intensity. The light will pass through the focal conic chiral nematic material and is depolarised again. This depolarised light passes through the front polarizer again, becomes polarized and its intensity is halved. The outgoing (polarized) light, viewed by the viewer, is white coloured with intensity 12.5%.

It will be understood from the foregoing that in the embodiment of FIG. 1, a first optical configuration embodying the invention is described. The black-and-white chiral nematic display configuration is made up by a chiral nematic display of any reflection spectrum and any elliptical polarization. The chiral nematic material selectively reflects and transmits light of certain elliptical (in particular, circular) polarizations. The angle between the front linear polarizer and the front quarter wave retardation film is optimized so that linear polarized light is converted into elliptically polarized light corresponding to that of the chiral nematic materials. The same is also achieved for the rear linear polarizer and the rear quarter wave retardation film. The front elliptically polarized light is adjusted to be of opposite polarity to that of the chiral nematic material. The angle between the rear linear polarizer and rear quarter wave retardation film is selected so that it is of the same polarity as the chiral nematic material.

The optical bright “ON” state of the configuration given by FIG. 1 is when the chiral nematic material is in the focal conic state and the optical dark “OFF” state is when the chiral nematic material is in the planar state.

The optical path description of the first optical configuration in the case of bright “ON” state is now described When incoming unpolarized light hits the font linear polarizer 2, 3, the light is linearly polarized and then enters to the quarter wave retardation film. The quarter wave retardation film converts the linear polarized light into elliptically polarized light having opposite polarity to the chiral nematic material. Half of the light is absorbed by the linear polarizer. After the front quarter wave retardation film, elliptically polarized light enters to the focal conic chiral nematic and is depolarised . This depolarised light passes through the rear quarter wave retardation film and the rear linear polarizer. After the rear linear polarizer, half of the light is blocked and the remaining polarization half becomes linear polarized It is then reflected by the mirror 9 and re-enters the rear linear polarizer 7, 8 and the rear quarter wave retardation film without any intensity attenuation Then it becomes elliptically polarized after the rear quarter wave retardation film and reenters to the focal conic chiral nematic. The elliptically polarized light is then depolarised . This depolarised light will be polarized after passing through the front polarizer and the intensity is halved again This polarized/depolarised /polarized/reflected/depolarised /polarized optical path is independent of the wavelength and the reflected light at the viewer consist of full spectrum white and the intensity is 12.5% of the original incoming light.

In the case of dark “OFF” state, the mechanism of the light through the front elliptical polarizer is the same as in the “ON” state. Elliptically polarized light of opposite polarity to the chiral nematic material enters into the intermediate chiral nematic material. In the planar state, this elliptically polarized light will transmit through the chiral nematic material without any change in polarization and intensity. This polarized light will enter to the rear elliptical polarizer (of opposite polarity) and is then completely absorbed. No light will enter to the reflector and therefore no light escapes to the viewer. This polarized/transmission/absorption optical path gives a dark state and zero reflectance to the viewer. The contrast of black-and-white in this first invented optical configuration is very high, and theoretically infinite contrast ratio.

In FIG. 2 the second optical configuration of the invention is described. The black-and-white chiral nematic display is made up by any chiral nematic display of any reflection spectrum and any elliptical polarization. Chiral nematic material selectively reflects and transmits light of certain elliptical (in particular, circular) polarizations. The angle between the front linear polarizer and the front quarter wave retardation film is optimised so that linear polarized light is converted into elliptically polarized light corresponding to that of the chiral nematic materials. The same is also achieved for the rear linear polarizer and the rear quarter wave retardation film. The front and rear elliptically polarized light are adjusted to be of opposite handedness as the chiral nematic material.

The optical bright “ON” state of the configuration given by FIG. 2 is when the chiral nematic material is in the planar state and the optical dark “OFF” state is when the chiral nematic material is in the focal conic state.

The optical path description in the case of bright “ON” state is now described. When incoming unpolarized light hits the front linear polarizer 2, 3 the outgoing light is linearly polarized and then enters to the quarter wave retardation film 5. The quarter wave retardation film converts the linear polarized light into elliptically polarized light having opposite polarity to the chiral nematic material. In the planar state, this elliptically polarized light will transmit through the chiral nematic material without any change in the polarization and intensity. This polarized light will enter to the rear elliptical polarizer (of same polarity), and exits as linear polarized light which when reflected will re-enter into linear polarizer of the rear elliptical polarizer without intensity attenuation. This light then exits the rear elliptical polarizer and passes through the planar state chiral nematic material of opposite polarity and the front elliptical polarizer of same polarity without any further change of polarization and intensity. The entire optical path is independent of wavelength and the outgoing light is white with intensity 50% as the original incoming light.

In the case of dark “OFF” state, the mechanism of the front linear polarizer and front quarter wave retardation film is the same as the “ON” state. Half of the light is absorbed by the front linear polarizer. The elliptically polarized light entering into the focal conic chiral nematic material is depolarised. This depolarised light passes through the rear quarter wave retardation film and the rear linear polarizer. At the rear linear polarizer, half of the light is absorbed and the other half is linear polarized. It is then reflected by the mirror and re-enter into the rear linear polarizer and the rear quarter wave retardation film and becomes elliptically polarized. This elliptically polarized light re-enters the focal conic chiral nematic and is depolarised again. This depolarised light is then polarized again by the front polarizer. This polarized/depolarised /polarized/reflected/depolarised /polarized optical path is independent of the wavelength and the outgoing light at the viewer has intensity 12.5% as the original incoming light, resulting in the dark state.

In the above two invented optical mode configurations, planar structure and focal conic structure can co-exist, that is, some area within the chiral nematic material is planar and some is focal conic. Different grey scales are achieved by different ratios of domains at planar structure and focal conic structure of the chiral nematic materials. Full “ON” and full “OFF”, different ratios of planar and focal conic structures can be controlled by any chiral nematic driving schemes. For example, these optical modes are applicable in the prior art driving schemes such as amplitude modulation, pulse width modulation, 3-phase dynamic driving, 5-phase dynamic driving, cumulative driving, dual frequency driving and multiple driving.

Other examples of suitable driving schemes are active matrix, passive matrix, grey scale, cumulative 2-phase, unipolar and multiple selection driving schemes.

Examples of the light paths in displays embodying the invention are set out in FIGS. 6 and 7. FIGS. 6a and 6b show light paths in states (1) to (4) in displays of the first optical configuration embodying the invention. FIG. 6a illustrates the light path for the planar state, further details of which are given in the Table below (Table I).

TABLE I
Planar State mode

| Light | | |
|---|---|---|
| Path | Light component | Comments |
| (1) | (100%) Unpolarised | White Light source |
| | light RGB | |
| (2) | (50%) LH RGB | All RH light is cut |
| (3) | (50%) LH RGB | The LH light passes unaffected |
| | | through the Planar state |
| (4) | (0%) No Light | All light of opposite polarity is |
| | | cut. Therefore no light reaches |
| | | mirror to reflect back to viewer |

FIG. 6 illustrates the light path in stages (1) to (8) for the focal conic state, further details of which are given in the Table below (Table II).

TABLE II
Focal Conic State mode

| Light | | |
|---|---|---|
| Path | Light component | Comments |
| (1) | (100%) Unpolarised light | White Light source |
| | RGB | |
| (2) | (50%) LH RGB | All RH light is cut |
| (3) | (50%) De-polarised RGB | Scattering from the Focal Conic state |
| | | affects all wavelengths |
| (4) | (25%) Linear polarised | Half of the light of opposite polarity to |
| | RGB | the RH CP is cut on exiting the linear |
| | | polariser side of the RH CP |
| (5) | (25%) Linear polarised | Linear Polarisation of the light remains |
| | RB | unchanged on reflection |
| (6) | (25%) RH RGB | The light becomes RH circularly |
| | | polarised as it exits the CP on the |
| | | retarder film side |
| (7) | (25%) De-Polarised RGB | Scattering from Focal Conic state |
| | | depolarises light again |
| (8) | (12.5%) Linear polorised | Half of the light of opposite polarity to |
| | RGB | the RH CP is cut on passing through the |
| | | RH CP. The light is linear on exiting |
| | | from the LP side |

FIGS. 7a and 7b illustrate the light path in displays of the second optical configuration embodying the invention. FIG. 7a illustrates the light path for the planar state mode stages (1) to (8). Further details of the light path set out in the Table below (Table III).

TABLE III
Planar State mode

| Light | | |
|---|---|---|
| Path | Light component | Comments |
| (1) | (100%) Unpolarised light | White Light source |
| | RGB | |
| (2) | (50%) LH RGB | All RH light is cut |
| (3) | (50%) LH RGB | The LH light passes unaffected through the Planar |
| | | state |
| (4) | (50%) Linear Polarised RGB | The LH light is allowed to pass through the LH |
| | | polariser but is linear as it exits from the linear |
| | | polariser side of the film |
| (5) | (50%) Linear polarised RGB | Linear Polarisation of the light remains |
| | | unchanged on reflection |
| (6) | (50%) LH RGB | The light becomes LH circularly polarised as it |
| | | exits the CP on the retarder film side |
| (7) | (50%) LH RGB | The LH light is again unchanged by passing |
| | | the RH SSCT of Planar state |
| (8) | (50%) Linear Polarised RGB | The LH light exits the LH CP film on the linear |
| | | Polariser side with linear polarisation |

FIG. 7b illustrates the light path of the focal conic state mode stages (1) to (8).

The light path for the focal conic state mode is set out in the steps 1 to 8 in the Table below (Table IV).

TABLE IV
Focal Conic State Mode

| Light | | |
|---|---|---|
| Path | Light component | Comments |
| (1) | (100%) Unpolarised | White Light source |
| | light RGB | |
| (2) | (50%) LH RGB | All RH light is cut |
| (3) | (50%) De-polarised RGB | Scattering from the Focal Conic state |
| | | affects all wavelengths |
| (4) | (25%) Linear polarised | Half of the light of opposite polarity |
| | RGB | to the RH CP is cut on exiting the |
| | | linear polariset side of the RH CP |
| (5) | (25%) Linear polarised | Linear Polarisation of the light |
| | RB | remains unchanged on reflection |
| (6) | (25%) RH RGB | The light becomes RH circularly |
| | | polarised as it exits the CP on the |
| | | retarder film side |
| (7) | (25%) De-Polarised | Scattering from Focal Conic state |
| | RGB | depolarises light again |
| (8) | (12.5%) Linear polorised | Half of the light of opposite polarity |
| | RGB | to the RH CP is cut on passing |
| | | through the RH CP. The light is |
| | | linear on exiting from the LP side |

1. A full spectrum black-and-white reflective chiral nematic display, comprising:
(i) a chiral nematic display of controllable planar structure and focal conic structure;
(ii) two transparent substrates said substrates having conductive electrodes;
(iii) two elliptical polarizers;
(iv) said chiral nematic liquid crystal material being between the two transparent substrates;
(v) said liquid crystal material and said transparent substrates being between said polarizers; and
(vi) the display further comprising an optical reflector.

2. A display device as defined in claim 1, wherein one elliptical polarizer is of opposite polarity to the chiral nematic liquid crystal material.

3. A display device as defined in claim 1, wherein there is an optically “ON” bright state when the chiral nematic materials are in the focal conic state.

4. A display device as defined in claim 1, wherein said optically “ON” bright state of full spectrum white.

5. A display device as defined in claim 1, wherein there is an optically “OFF” dark state when the chiral nematic material is in the planar state.

6. A display device as defined in claim 1, wherein the chiral nematic material has the reflection spectrum of a particular peak wavelength and elliptical polarization.

7. A display device as defined in claim 1, wherein the two elliptical polarizers are of opposite polarities.

8. A display device as defined in claim 1, wherein the two elliptical polarizers are selected from the group comprising wideband and otherwise than wideband.

9. A display device as defined in claim 1, wherein the chiral nematic display is sandwiched between two orthogonal elliptical polarizers and wherein the reflector is laminated on the rear elliptical polarizer.

10. A display device as defined in claim 1, wherein the arrangement of front and rear elliptical polarizers is such that the light entering into the chiral nematic material from above or below is elliptically polarized.

11. A display device as defined in claim 1, wherein the arrangement of the rear elliptical polarizer is such that the light incident on the reflector is linearly polarized.

12. A display device as defined in claim 1, wherein the light leaving the front elliptical polarizer entering the chiral nematic material is elliptically polarized with opposite polarity to that of the chiral nematic material, the front elliptical polarizer being of opposite polarity to the chiral nematic material.

13. A display device as defined in claim 1, wherein the rear elliptical polarizer is of the same polarity as the chiral nematic material.

14. A display device as defined in claim 1, wherein the reflector is diffusive.

15. A display device as defined in claim 1, wherein the “ON” state is caused by depolarization of light passing through the focal conic state chiral nematic material.

16. A display device as defined in claim 1, wherein in the “ON” state of the device the depolarisation is independent of wavelength.

17. A display device as defined in claim 1, wherein in the “OFF” state of the device the opposite polarity of elliptically polarized light enters into the planar state chiral nematic material and passes through without any polarization change.

18. A full spectrum black-and-white reflective chiral nematic display, comprising:
(i) a chiral nematic display of controllable planar structure and focal conic structure;
(ii) two transparent substrates said substrates having conductive electrodes;
(iii) two elliptical polarizers;
(iv) said chiral nematic liquid crystal material being between the two transparent substrates;
(v) said liquid crystal material and said transparent substrates being between said polarizers;
(vi) the display further comprising an optical reflector; and
(vii) both optical polarisers being arranged to exhibit a handedness opposite to the handedness of the chiral nematic liquid crystal material.
